(19) United States
(12) Patent Application Publication
(10) Pub. No.: US 2024/0232571 A1
(43) Pub. Date: Jul. 11, 2024

(54) Palettization of Kernel Vector in Neural Network Processor

(71) Applicant: Apple Inc., Cupertino, CA (US)

(72) Inventor: Sung Hee Park, San Jose, CA (US)

(21) Appl. No.: 18/094,251

(22) Filed: Jan. 6, 2023

(51) Int. Cl. G06N 3/04; G06F 7/50; G06F 7/523

(52) U.S. Cl. CPC G06N 3/04; G06F 7/50; G06F 7/523

(57) ABSTRACT

Embodiments of the present disclosure relate to decompressing a kernel for neural network operations in a neural processor circuit, using a look-up table (LUT) with each of its entries associated with a plurality of kernel coefficients. Index data in compressed kernel data includes indices that indicate entries in the LUT. During decompression, all kernel coefficients in entries as indicated by the indices of the index data are retrieved and assembled into the decompressed kernel. A block sparse mask may also be used to indicate a block of locations in the uncompressed kernel to be filled with zero values. Only one or more blocks of locations indicated by the block sparse mask to include at least one none-zero kernel coefficient may be populated with the kernel coefficients from the LUT while remaining blocks of locations are padded with zero.

### BACKGROUND

### 1. Field of the Disclosure

The present disclosure relates to palletizing kernel vectors for performing neural network operations, and more specifically to storing and decompressing sets of kernel coefficients as palletized vectors.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configuration would include, for example, pre-processing operations, the number of channels in input data, kernel data to be used, non-linear function to be applied to convolution result, and applying of various post-processing operations. Using a central processing unit (CPU) and its main memory to instantiate and execute machine learning systems or models of various configuration is relatively easy because such systems or models can be instantiated with mere updates to code. However, relying solely on the CPU for various operations of these machine learning systems or models would consume significant bandwidth of the CPU as well as increase the overall power consumption.

### SUMMARY

Embodiments relate to decompressing of a kernel for performing neural network operations in a neural processor circuit using a look-up table where a plurality of kernel coefficients are stored in each entry. The neural processor circuit includes a kernel access circuit coupled to memory external to the neural processor circuit and a plurality of neural engine circuits. A neural engine circuit includes a kernel extract circuit that extracts a look-up table by decompressing compressed kernel data. The look-up table has a plurality of kernel coefficients in each entry that is identified by an index. Indices for an uncompressed kernel is extracted from the compressed kernel data, and the uncompressed kernel is assembled by identifying kernel coefficients in entries of the look-up table corresponding to the extracted indices. A multiply-add (MAD) circuit in the neural engine circuit receives the uncompressed kernel data and performs neural network operations on a portion of input data using the uncompressed kernel.

### BRIEF DESCRIPTION OF THE DRAWINGS

Figure (FIG. 1 is a high-level diagram of an electronic device, according to one embodiment.

FIG. 2 is a block diagram illustrating components in the electronic device, according to one embodiment.

FIG. 3 is a block diagram illustrating a neural processor circuit, according to one embodiment.

FIG. 4 is a block diagram of a neural engine in the neural processor circuit, according to one embodiment.

FIG. 5 is a block diagram illustrating the flow of compressed kernel data to neural engines, according to one embodiment.

FIG. 6 is a conceptual diagram illustrating the use of a look-up table (LUT) and a block sparse mask to generate decoded kernel coefficients, according to one embodiment.

FIG. 7 is a block diagram of a kernel extract circuit, according to one embodiment.

FIG. 8 is a flow chart illustrating a process of decompressing compressed kernel data, according to one embodiment.

The figures depict and the detail description describes various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to decompressing a kernel for neural network operations in a neural processor circuit, using a look-up table (LUT) with each of its entries associated with a plurality of kernel coefficients. Index data in compressed kernel data includes indices that indicate entries in the LUT. During decompression, all kernel coefficients in entries as indicated by the indices of the index data are retrieved and assembled into the decompressed kernel. A block sparse mask may also be used to indicate a block of locations in the uncompressed kernel to be filled with zero values. Only one or more blocks of locations indicated by the block sparse mask to include at least one none-zero kernel coefficient may be populated with the kernel coefficients from the LUT while remaining blocks of locations are padded with zero.

### Exemplary Electronic Device

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

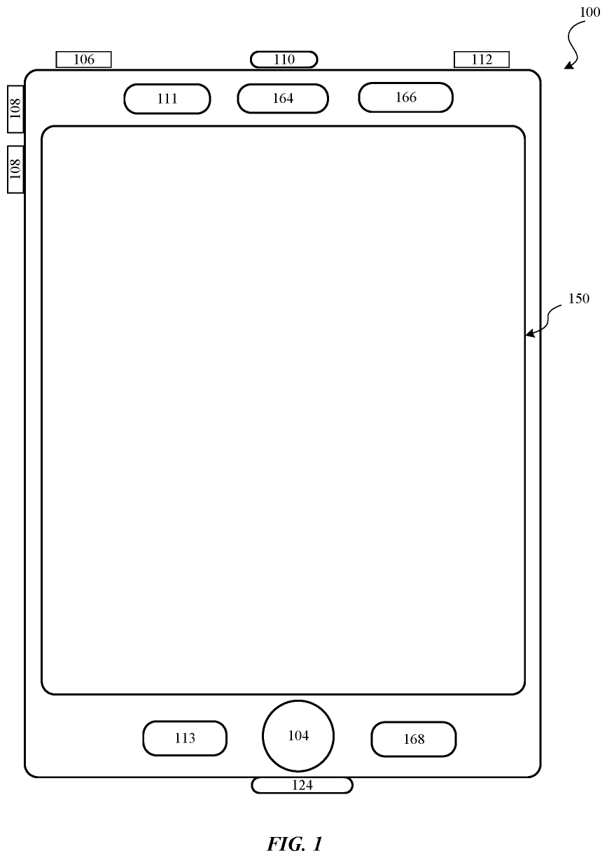

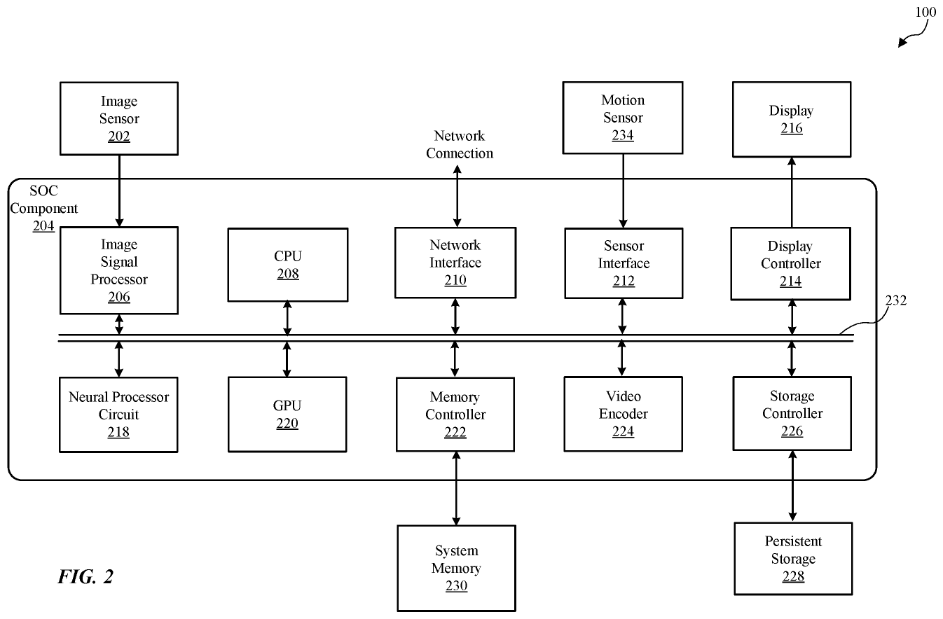

FIG. 2 is a block diagram illustrating components in device 100, according to one embodiment. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

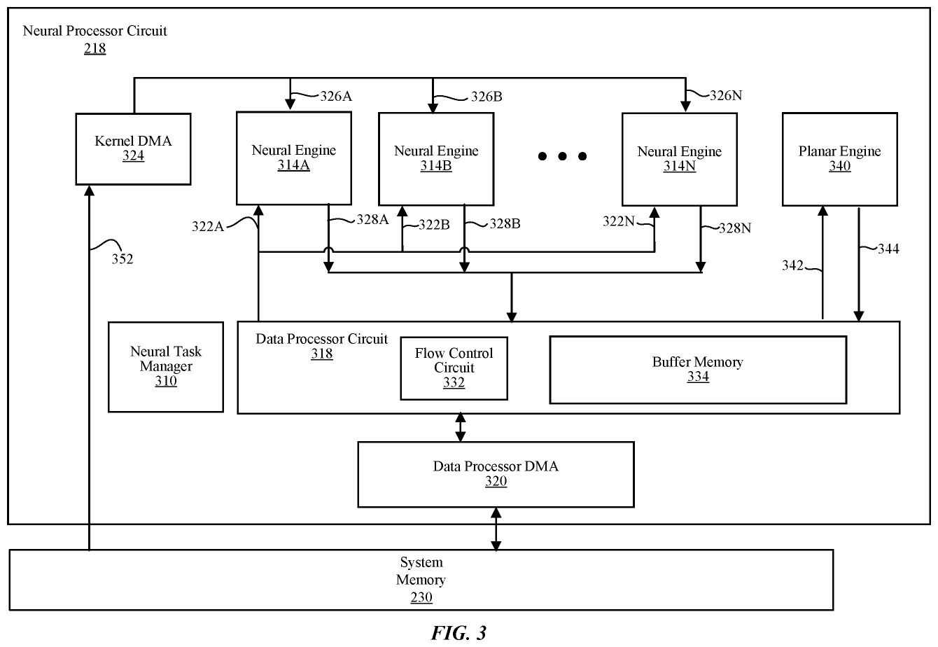

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, the image signal processor 206, persistent storage 228, system memory 230 or other sources such as network interface 210 or GPU 220. The output of neural processor circuit 218 may be provided to various components of device 100 such as image signal processor 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as hidden layers. Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computation operation such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, neural processor circuit 218 may also be used for the operations of other types of machine learning models, such as a kernel SVM.

Referring to FIG. 3, an example neural processor circuit 218 may include, among other components, a neural task manager 310, neural engines 314A through 314N (hereinafter collectively referred as “neural engines 314” and individually also referred to as “neural engine 314”), a kernel direct memory access (DMA) 324, a data processor circuit 318, a data processor DMA 320, and a planar engine 340. Neural processor circuit 218 may include fewer or additional components not illustrated in FIG. 3.

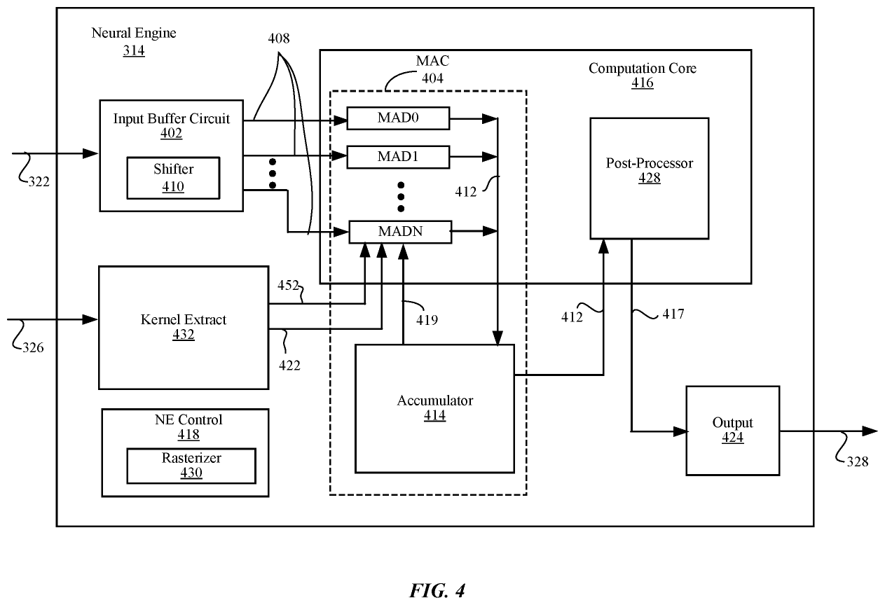

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, and for post-processing to generate an output data 328, as described below in detail with reference to FIG. 4. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions.

Planar engine 340 may specialize in performing simpler computing operations whose speed may primarily depend on the input and output (I/O) speed of the data transmission instead of the computation speed within planar engine 340. Those computing operations may be referred to as I/O bound computations. In contrast, neural engines 314 may focus on complex computation whose speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In one embodiment, input data may be a tensor whose rank is larger than three (e.g., having three or more dimensions). A set of dimensions (two or more) in the tensor may be referred to as a plane while another dimension may be referred to as a channel. Neural engines 314 may convolve data of a plane in the tensor with a kernel and accumulate results of the convolution of different planes across different channels. On the other hand, planar engine 340 may specialize in operations within the plane.

The circuitry of planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor.

Neural task manager 310 manages the overall operation of neural processor circuit 218. Neural task manager 310 may receive a task list from a compiler executed by CPU 208, store tasks in its task queues, choose a task to perform, and send task commands to other components of neural processor circuit 218 for performing the chosen task. Data may be associated with a task command that indicates the types of operations to be performed on the data. Data of neural processor circuit 218 includes input data that is transmitted from another source such as system memory 230, and data generated by neural processor circuit 218 in a previous operating cycle. Each dataset may be associated with a task command that specifies the type of operations to be performed on the data. Neural task manager 310 may also perform switching of tasks on detection of events such as receiving instructions from CPU 208. In one or more embodiments, neural task manager 310 sends rasterizer information to the components of neural processor circuit 218 to enable each of the components to track, retrieve or process appropriate segments of the input data and kernel data. For example, neural task manager 310 may include registers that stores the information regarding the size and rank of a dataset for processing by neural processor circuit 218. Although neural task manager 310 is illustrated in FIG. 3 as part of neural processor circuit 218, neural task manager 310 may be a component outside neural processor circuit 218.

Kernel DMA 324 is a read circuit that fetches kernel data 352 from a source (e.g., system memory 230), processes (e.g., replicates or devices) kernel data 352 into neural engine (NE) kernel data 326A through 326N appropriate for each neural engines, and sends NE kernel data 326A through 326N to each of neural engines 314. NE kernel data 326A through 326N represents information from which kernel coefficients can be extracted, and kernel data 352 represents information from which NE kernel data 326 through 326N can be derived. In one embodiment, the kernel data 352 or NE kernel data 326 may be in a compressed format which is decompressed at each of neural engines 314. Although NE kernel data provided to each of neural engines 314 may be the same in some instances, the NE kernel data provided to each of neural engines 314 is different in most instances. In one embodiment, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a flow control circuit 332 and a buffer memory 334. Buffer memory 334 is temporary storage for storing data associated with operations of neural processor circuit 218 and planar engine 340, such as input data that is transmitted from system memory 230 (e.g., data from a machine learning model) and other data that is generated within neural processor circuit 218 or planar engine 340. The data stored in data processor circuit 318 may include different subsets that are sent to various downstream components, such as neural engines 314 and planar engine 340.

In one embodiment, buffer memory 334 is embodied as a non-transitory memory that can be accessed by neural engines 314 and planar engine 340. Buffer memory 334 may store input data 322A through 322N for feeding to corresponding neural engines 314A through 314N or planar engine 340, as well as output data 328A through 328N from each of neural engines 314A through 314N or planar engine 340 for feeding back into one or more neural engines 314 or planar engine 340, or sending to a target circuit (e.g., system memory 230). Buffer memory 334 may also store input data 342 and output data 344 of planar engine 340 and allow the exchange of data between neural engine 314 and planar engine 340. For example, one or more output data 328A through 328N of neural engines 314 are used as input data 342 to planar engine 340. Likewise, output data 344 of planar engine 340 may be used as the input data 322A through 322N of neural engines 314. The inputs of neural engines 314 or planar engine 340 may be any data stored in buffer memory 334. For example, in various operating cycles, the source datasets from which one of the engines fetches as inputs may be different. The input of an engine may be an output of the same engine in previous operating cycles, outputs of different engines, or any other suitable source datasets stored in buffer memory 334. Also, a dataset in buffer memory 334 may be divided and sent to different engines for different operations in the next operating cycle. Two datasets in buffer memory 334 may also be joined for the next operation.

Flow control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Flow control circuit 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., the data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to the planar engine 340 to direct planar engine 340 to program itself for operating in one of multiple operation modes.

The data of neural processor circuit 218 stored in buffer memory 334 may be part of, among others, image data, histogram of oriented gradients (HOG) data, audio data, metadata, output data 328 of a previous operating cycle of neural engine 314, and other processed data received from other components of SOC component 204.

Data processor DMA 320 includes a read circuit that receives a segment of the input data from a source (e.g., system memory 230) for storing in buffer memory 334, and a write circuit that forwards data from buffer memory 334 to a target component (e.g., system memory 230). In one embodiment, the direct memory access nature of data processor DMA 320 may allow data processor DMA 320 to fetch and write data directly from a source (e.g., system memory 230) without the involvement of CPU 208. Buffer memory 334 may be a direct memory access buffer that stores data of a machine learning model of device 100 without involvement of CPU 208.

### Example Neural Engine Architecture

FIG. 4 is a block diagram of neural engine 314, according to one embodiment. Neural engine 314 performs various operations to facilitate machine learning such as convolution, tensor product, and other operations may involve heavy computation. For this purpose, neural engine 314 receives input data 322, performs multiply-accumulate operations (e.g., convolution operations) on input data 322 based on an uncompressed kernel, performs further post-processing operations on the result of the multiply-accumulate operations, and generates output data 328. Input data 322 and/or output data 328 of neural engine 314 may be of a single channel or span across multiple channels.

Neural engine 314 may include, among other components, input buffer circuit 402, computation core 416, neural engine (NE) control 418, kernel extract circuit 432, accumulator circuit 414 and output circuit 424. Neural engine 314 may include fewer components than what is illustrated in FIG. 4 or include further components not illustrated in FIG. 4.

Input buffer circuit 402 is a circuit that stores a subset of the data of neural processor circuit 218 as the subset of data is received from a source. The source may be data processor circuit 318, planar engine 340, or another suitable component. Input buffer circuit 402 sends an appropriate segment 408 of data for a current task or process loop to computation core 416 for processing. Input buffer circuit 402 may include a shifter 410 that shifts read locations of input buffer circuit 402 to change segment 408 of data sent to computation core 416. By changing segments of input data provided to computation core 416 via shifting, neural engine 314 can perform multiply-accumulate for different segments of input data based on a fewer number of read operations. In one or more embodiments, the data of neural processor circuit 218 includes data of difference convolution groups and/or input channels.

Kernel extract circuit 432 is a circuit that receives NE kernel data 326 from kernel DMA 324 and extracts kernel coefficients 422. In one embodiment, kernel extract circuit 432 references a lookup table (LUT) and uses a block sparse mask to reconstruct a kernel from compressed NE kernel data 326 based on the LUT. The block sparse mask indicates blocks of locations in the reconstructed kernel to be padded with zero and remaining locations to be filled with numbers. Kernel coefficients 422 of the reconstructed kernel are sent to computation core 416 to populate register in multiply-add (MAD) circuits of computation core 416.

Computation core 416 is a programmable circuit that performs computation operations. For this purpose, computation core 416 may include MAD circuits MAD0 through MADN and a post-processor 428. Each of MAD circuits MAD0 through MADN may store an input value in the segment 408 of the input data and a corresponding kernel coefficient in kernel coefficients 422. The input value and the corresponding kernel coefficient are multiplied in each of MAD circuits to generate a processed value 412.

Accumulator circuit 414 is a memory circuit that receives and stores processed values 412 from MAD circuits. The processed values stored in accumulator circuit 414 may be sent back as feedback information 419 for further multiply and add operations at MAD circuits or sent to post-processor 428 for post-processing. Accumulator circuit 414 in combination with MAD circuits form a multiply-accumulator (MAC) 404. In one or more embodiments, accumulator circuit 414 may have subunits (or batches) where each subunit sends data to different components of neural engine 314. For example, during an operating cycle, data stored in a first subunit of accumulator circuit 414 is sent to MAC 404 while data stored in a second subunit of accumulator circuit 414 is sent to post-processor 428.

Post-processor 428 is a circuit that performs further processing of values 412 received from accumulator circuit 414. Post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values 417 to output circuit 424. In some embodiments, the processing at post-processor 428 is bypassed. For example, the data in accumulator circuit 414 may be sent directly to output circuit 424 for access by other components of neural processor circuit 218.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator circuit 414 to MAD circuits, and perform different types of post-processing operations at post-processor 428. To configure components of neural engine 314 to operate in a desired manner, NE control 418 sends task commands that may be included in information 419 to components of neural engine 314. NE control 418 may include a rasterizer 430 that tracks the current task or process loop being processed at neural engine 314.

Input data is typically split into smaller pieces of data for parallel processing at multiple neural engines 314 or neural engines 314 and planar engine 340. A set of data used for a convolution operation may be referred to as a convolution group, which can be split into multiple smaller units. The hierarchy of smaller units (segments) may be convolution groups, slices, tiles, work units, output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed during a prior operating cycle of neural engines 314 having a size that produces output values that fit into accumulator circuit 414 of neural engine 314 during a single operating cycle of computation core 416. In one case, the size of each work unit is 256 bytes. In such embodiments, for example, work units can be shaped to one of 16×16, 32×8, 64×4, 128×2 or 256×1 datasets. In the context of planar engine 340, a work unit may be (i) a segment of input data, (ii) data from neural engine 314 or (iii) data from a prior operating cycle of planar engine 340 that can be processed simultaneously at planar engine 340.

Rasterizer 430 may perform the operations associated with dividing the input data into smaller units (segments) and regulate the processing of the smaller units through MACs 404 and accumulator circuit 414. Rasterizer 430 keeps track of sizes and ranks of segments of the input/output data (e.g., groups, work units, input channels, output channels) and instructs the components of neural processor circuit 218 for proper handling of the segments of the input data. For example, rasterizer 430 operates shifters 410 in input buffer circuits 402 to forward correct segments 408 of input data to MAC 404 and send the finished output data 328 to data buffer memory 334. Other components of neural processor circuit 218 (e.g., kernel DMA 324, buffer DMA 320, buffer memory 334, planar engine 340) may also have their corresponding rasterizers to monitor the division of input data and the parallel computation of various segments of input data in different components.

Output circuit 424 receives processed values 417 from post-processor 428 and interfaces with data processor circuit 318 to store processed values 417 in data processor circuit 318. For this purpose, output circuit 424 may send out output data 328 in a sequence or a format that is different from the sequence or format in which the processed values 417 are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processor 428.

### Example Distribution and Decompression of Kernel Data

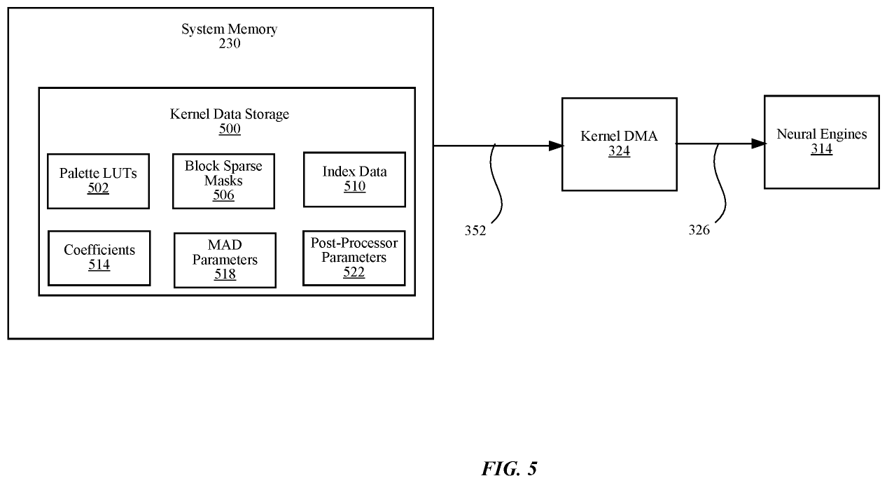

FIG. 5 is a block diagram illustrating flow of compressed kernel data to neural engine 314, according to one embodiment. System memory 230 includes kernel data storage 500 that stores kernel data associated with performing neural operations on neural engines 314. The kernel data in kernel data storage 500 may be generated during a compilation process and may include data for multiple levels of ANN or multiple ANNs.

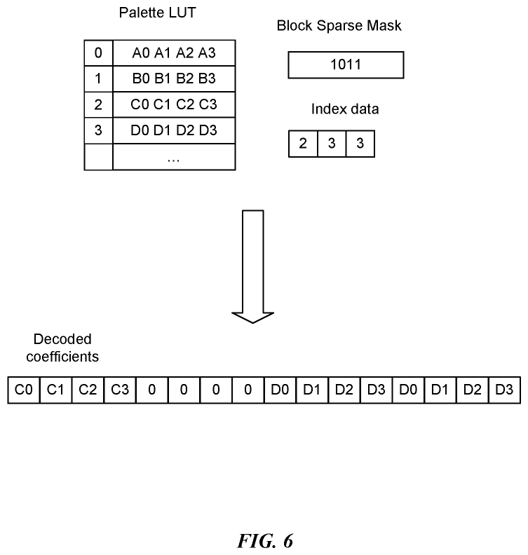

Kernel data stored in kernel data storage 500 may include information for assembling kernels at neural engines 314 as well as other information for performing neural processing operation at neural engines 314. Information for assembling kernels may include, among other data, look-up tables (LUTs) 502, block sparse masks 506, index data 510, and kernel coefficients 514, as described below in detail with reference to FIG. 6. The other information for neural engines 314 may include MAD parameters 518 and post-processor parameters 522. MAD parameters 518 indicates configuration or processes of MAD in neural engines 314, and may include a channel bias or a shift to be used with an operation. Post-processor parameters 522 indicates configuration or processes at post-processor 428, and may include a function to be used for processing values 412 generated by the MAC 404. Kernel data storage 500 stores information for multiple layers and/or different ANNs.

Kernel DMA 324 fetches kernel data 352 relevant to current or subsequent neural operations and assembles kernel data 352 into NE kernel data 326 to be sent to each of the neural engines 314. Kernel data storage 500 may include data for an different layers of ANN or multiple ANNs, and hence, kernel DMA 324 collects, from kernel data storage 500, index data 510, parts of kernel data 352 that is applicable to current or subsequent operation of neural engines 314, packs the collected data into a predetermined format, and sends the collected data as NE kernel data 326 to neural engines 314. In one or more embodiments, NE kernel data 326 may be in the form of a data block that includes a LUT with entries of coefficient identifiers and a block sparse mask followed by actual coefficient values mapped to the coefficient identifiers. Each entry in the LUT includes identifiers for multiple coefficients, as described below in detail with reference to FIG. 6.

FIG. 6 is a conceptual diagram illustrating the use of a LUT and a block sparse mask to generate decoded kernel coefficients, according to one embodiment. After kernel extract circuit 432 of neural engines 314 receives NE kernel data 326, kernel extract circuit 432 decodes NE kernel data 326 into an uncompressed kernel. Specifically, kernel extract circuit 432 reads the block sparse mask that indicates where one or more blocks of zero kernel coefficients are located and where blocks include at least one non-zero kernel coefficients are located. Then, kernel extract circuit 432 refers to index data that indicates entries in the LUT to identify a plurality of kernel coefficients to populate blocks with non-zero kernel coefficients. Each entry in the LUT includes a plurality of coefficient identifiers where each coefficient identifier corresponds to a kernel coefficient value.

In the example of FIG. 6, an entry in the LUT includes 4 elements, and the block sparse mask includes 4 digits. The block sparse mask includes 3 non-zero bits and one zero bit, and the index data has three numbers corresponding to each non-zero bit of the block sparse mask. In the LUT, the first entry (index 0) has four identifiers of A0, A1, A2, A3, the second entry (index 1) has four identifiers of B0, B1, B2, B3, the third entry (index 2) has four identifiers of C0, C1, C2, C3, and the fourth entry (index 3) has four identifiers of D0, D1, D2, D3. The block sparse mask is four bits long, with only the second bit being zero while the remaining bits are 1. The bit sequence in the block sparse mask means that the second block of coefficients is all zero while the remaining blocks include at least one coefficient that is non-zero. Index data indicates that kernel coefficients corresponding to the first block of index data are to be populated using four coefficients (C0, C1, C2, C3) in index 2 (third index) while the kernel coefficients corresponding to third and fourth blocks of index data are to be populated using four coefficients (D0, D1, D2, D3) in index 3.

The resulting uncompressed kernel includes the first block of four coefficients (C0 through C3), followed by four zero-value coefficients, and then two repeating blocks (D0 through D3) of coefficients. Although FIG. 6 illustrates a series of indices A0 through D3 in decoded coefficients, in practice, indices A0 through D3 are replaced with actual values of coefficients in NE kernel data 326. The series of decoded coefficients 422 is sent to MAD of computation core 416 for performing multiplication operations.

By using the LUT, block sparse mask and index data, the amount of data stored in kernel data storage 500 may be reduced relative to storing entire kernel coefficients of kernels in kernel data storage 500 while preserving flexibility of using various arrangements of kernel coefficients. That is, a set of coefficients in the LUT that are reused across different blocks may not be stored in duplicate in kernel data storage 500. Further, blocks of zero coefficients are represented by a single bit in block sparse mask, which also reduces the amount of data used for storing sparse kernels.

### Example Structure of Kernel Extract Circuit

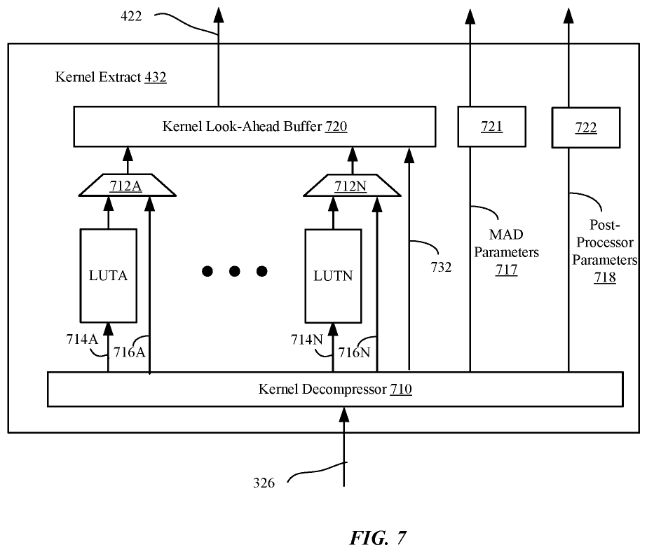

FIG. 7 is a block diagram of kernel extract circuit 432, according to one embodiment. The kernel extract circuit 432 receives the compressed NE kernel data 326 from kernel DMA 324 circuit and extracts uncompressed kernel coefficients 422. Kernel extract circuit 432 extracts the uncompressed kernel data by using LUTs, block sparse masks and index data, as described above with reference to FIG. 6.

Kernel extract circuit 432 may include, among other components, a kernel decompressor 710, palletized look-up table storage LUTA through LUTN, reconstruction circuits 712A through 712N, a kernel look-ahead buffer 720, MAD parameter buffer 721, and post-processor parameter buffer 722. Kernel extract circuit 432 may include fewer or additional components than the components illustrated in FIG. 7.

Kernel decompressor 710 is a circuit that separates the compressed kernel data 326 and sends it to other components of the kernel extract circuit 432. Kernel decompressor 710 may extract LUT information 714A through 714N, LUT identification 716A through 716N, block sparse mask 732, MAC parameters 717, and post-processor parameters 718 from compressed kernel data 326. To prepare LUT information 714A through 714N, kernel decompressor 710 reads kernel coefficient identifiers for each entry in the LUTs, and populates the entries in LUTs with kernel coefficient values identified by kernel coefficients identifiers.

Kernel decompressor 710 sends the LUT identification 716A through 716N to a corresponding look-up table storage LUTA through LUTN. Each LUT information 714A through 714N may include entries with identifications and corresponding blocks of multiple kernel coefficients. Each LUT identification 716A through 716N may indicate the identification of a LUT (of multiple LUTs) to be used, and indices from index data, as described above with reference to FIG. 6. Kernel decompressor 710 also extracts and sends block sparse mask 732 to kernel decompressor 710 for placing one or more blocks of zero coefficients in a kernel. Although multiple LUTs are illustrated in FIG. 7 as being included in kernel extract circuit 432, only a single LUT may be included in kernel extract circuit 432.

Kernel decompressor 710 sends MAD parameters 717 to the MAD parameter buffer 721. The MAD parameters 717 are sent to the MAD circuit of each of the neural engine circuits to configure operations of the MAD circuit. For example, a MAD parameter 717 includes a channel bias or a shift to be used with an operation.

Kernel decompressor 710 sends post-processor parameters 718 to post-processor parameter buffer 722. Post-processing parameters 718 are sent to a post-processer (e.g., post-processor 428) of each of the neural engine circuits to configure operations of the post-processor. For example, post-processing parameters 718 are values that collectively represent a function used for processing values 412 generated by the MAC 404.

LUT storage LUTA through LUTN stores look-up tables storing entries where each entry is associated with a plurality of kernel coefficients. Each of the entries are identified by index values in index data. The LUT storage LUTA through LUTN receives LUT information 714A through 714N from the kernel decompressor 710. One or more LUTs may be configurable to support various numbers and patterns of kernel coefficients in each of their entries. For example, one or more kernel coefficients in an entry of an LUT may have a zero value. Depending on the number of entries or patterns of kernel coefficients, a single large LUT or more than one smaller LUT may be used.

Reconstruction circuit 712A through 712N reconstructs blocks of kernel coefficients by referencing a LUT identified by a corresponding LUT identification 716A through 716N in the look-up table storage LUTA through LUTN to determine coefficient values to be filled in blocks of kernel where at least one kernel coefficient is non-zero, as indicated by the block sparse mask 732. Reconstruction circuit 712A through 712N sends a block of the uncompressed kernel data to a kernel look-ahead buffer 720 for storage.

Kernel look-ahead buffer 720 stores uncompressed kernel data. The kernel look-ahead buffer 720 receives uncompressed blocks of kernel coefficients from the reconstruction circuits 712A through 712N. Kernel look-ahead buffer 720 then fills locations of a kernel where sparse block mask 732 indicates non-zero values with the uncompressed kernel coefficients while filling the remaining locations with zeros. Kernel look-ahead buffer 720 sends information on locations of kernel coefficients that are zero in the uncompressed kernel data to a MAD circuit (e.g., MAD0 through MADN) in advance before sending remaining kernel coefficients that are non-zero to the MAD circuit so that the MAD circuit can skip multiply-add operations associated with the kernel coefficient that are zero.

In one embodiment, kernel look-ahead buffer 720 can be used to generate relevant control signals (e.g., control signals 452) for a computation core 416 in a neural engine 314. The control signals 452 may then instruct neural engine 314 to skip operations for kernel coefficients that have zero values. For example, look-ahead buffer 720 may have information of the locations of zero entries in a kernel. Thus, control signals may be generated for the neural engine 314 to skip an operation for MAD for a particular location in the kernel. Thus, instead of sequentially stepping through each kernel location of the kernel to perform an operation with the kernel coefficient associated with the kernel location, operations associated with the zero entries can be skipped.

### Example Processes at Neural Engine Architecture

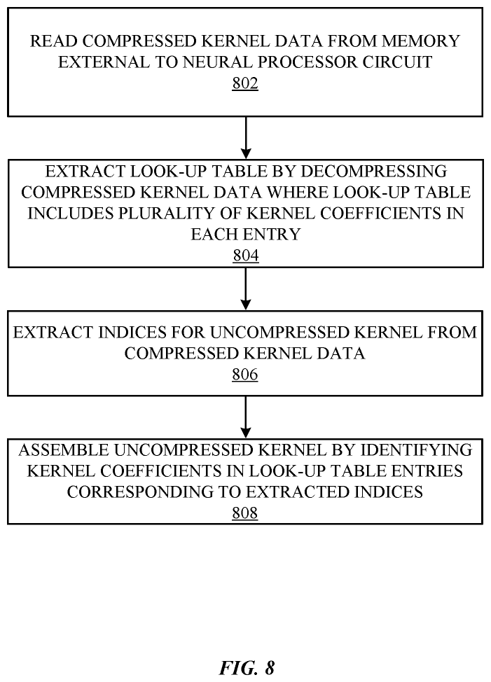

FIG. 8 is a flow chart illustrating a process of decompressing compressed kernel data, according to one embodiment. Kernel DMA 324 receives 802 compressed kernel data from system memory 230 that is external to neural processor circuit 218. Kernel DMA 324 sends compressed kernel data to neural engines 314.

From compressed kernel data, kernel extract 804 circuit 432 of neural engines 314 extracts 804 one or more LUTs. In each LUT, each of its entries include a plurality of kernel coefficients. These kernel coefficients are used for filling blocks of an uncompressed of kernel coefficients at locations where an associated block sparse mask indicates presence of at least one non-zero kernel value.

Kernel extract circuit extracts 806 indices for the kernel from compressed kernel data. The indices may be included in the compressed kernel data as a series of numbers that indicate entries of the LUTs. The indices may be included in the compressed kernel data as index data.

Kernel extract circuit then assembles 808 the kernel by identifying the kernel coefficients in LUTs and filling corresponding locations of the kernel with the indices. In locations where the block sparse mask indicates zero kernel values, kernel extract circuit files them with zero values.

The process illustrated with FIG. 8 is merely illustrative, and various modifications may be made. For example, instead of performing extracting 804 of LUTs and extracting 806 of indices in series, both operations may be performed at least partly in parallel.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A neural processor circuit, comprising:
a kernel access circuit coupled to memory external to the neural processor circuit, the kernel access circuit configured to read compressed kernel data from the memory; and
a plurality of neural engine circuits configured to receive compressed kernel data from the kernel access circuit, each of the neural engine circuits comprising:
a kernel extract circuit configured to:
extract a look-up table by decompressing the compressed kernel data, the look-up table having a plurality of kernel coefficients in each entry identified by an index,
extracting indices for an uncompressed kernel from the compressed kernel data, and
assembling the uncompressed kernel by identifying kernel coefficients in entries of the look-up table corresponding to the extracted indices; and
a multiply-add (MAD) circuit coupled to the kernel decompression circuit to receive the uncompressed kernel data, the MAD circuit further configured to perform neural network operations on a portion of input data using the uncompressed kernel data.

2. The neural processor circuit of claim 1, wherein each of the entries in in the look-up table includes a same number of kernel coefficients.

3. The neural processor circuit of claim 1, wherein the kernel extract circuit is further configured to extract a block sparse mask that indicates one or more blocks of uncompressed kernel data to be filled with zero.

4. The neural processor circuit of claim 3, wherein the block sparse mask includes a series of bits of a first value indicating a subset of kernel coefficients in the uncompressed kernel data that are zero and a second value indicating another subset of kernel coefficients in the uncompressed kernel data that are non-zero.

5. The neural processor circuit of claim 1, wherein the kernel extract circuit comprises a kernel look-ahead buffer storing information on locations where kernel coefficients in the uncompressed kernel data are zero, the information on the locations sent to the MAD circuit to skip multiply-add operations associated with the kernel coefficients that are zero.

6. The neural processor circuit of claim 1, wherein the compressed kernel data comprises the look-up table, a MAD parameter for configuring operations of the MAD circuit in each of the neural engine circuits, and a post-processor parameter for configuring a post-processor in each of the neural engine circuits.

7. The neural processor circuit of claim 6, wherein the kernel extract circuit is further configured to:
extract the MAD parameter and the post-processor parameter from the compressed kernel data,
send the MAD parameter to the MAD circuit, and
send the post-processor parameter to the post-processor.

8. The neural processor circuit of claim 1, wherein at least one kernel coefficient in the look-up table is zero.

9. A method of operating a neural processor circuit, comprising:
reading, by a kernel access circuit, compressed kernel data from a memory external to the neural processor circuit;
receiving, by a plurality of neural engine circuits, compressed kernel data from the kernel access circuit, each of the neural engine circuits comprising a kernel extract circuit an a multiply-add (MAD) circuit;
extracting at least a look-up table by decompressing the compressed kernel data in the neural engine circuits, the look-up table having a plurality of kernel coefficients in each entry identified by an index;
extracting indices for an uncompressed kernel from the compressed kernel data;
assembling the uncompressed kernel by identifying kernel coefficients in entries of the look-up table corresponding to the extracted indices; and
performing, by the MAD circuit, neural network operations on a portion of input data using the uncompressed kernel data.

10. The method of claim 9, wherein each of the entries in in the look-up table includes a same number of kernel coefficients.

11. The method of claim 9, further comprising extracting a block sparse mask that indicates one or more blocks of uncompressed kernel data to be filled with zero.

12. The method of claim 11, wherein the block sparse mask includes a series of bits of a first value indicating a subset of kernel coefficients in the uncompressed kernel data that are zero and a second value indicating another subset of kernel coefficients in the uncompressed kernel data that are non-zero.

13. The method of claim 9, storing information on locations where kernel coefficients in the uncompressed kernel data are zero in a kernel look-ahead buffer of the kernel extract circuit, the information on the locations sent to the MAD circuit to skip multiply-add operations associated with the kernel coefficients that are zero.

14. The method of claim 9, wherein the compressed kernel data comprises the look-up table, a MAD parameter for configuring operations of the MAD circuit in each of the neural engine circuits, and a post-processor parameter for configuring a post-processor in each of the neural engine circuits.

15. The method of claim 14, further comprising:
extracting the MAD parameter and the post-processor parameter from the compressed kernel data,
sending the MAD parameter to the MAD circuit, and
sending the post-processor parameter to the post-processor.

16. The method of claim 9, wherein at least one kernel coefficient in the look-up table is zero.

17. An electronic device, comprising:
a system memory storing input data; and
a neural processor circuit coupled to the system memory, the neural processor circuit including:
a kernel access circuit coupled to memory external to the neural processor circuit, the kernel access circuit configured to read compressed kernel data from the memory; and
a plurality of neural engine circuits configured to receive compressed kernel data from the kernel access circuit, each of the neural engine circuits comprising:
a kernel extract circuit configured to:
extract a look-up table by decompressing the compressed kernel data, the look-up table having a plurality of kernel coefficients in each entry identified by an index,
extracting indices for an uncompressed kernel from the compressed kernel data, and
assembling the uncompressed kernel by identifying kernel coefficients in entries of the look-up table corresponding to the extracted indices; and
a multiply-add (MAD) circuit coupled to the kernel decompression circuit to receive the uncompressed kernel data, the MAD circuit further configured to perform neural network operations on a portion of input data using the uncompressed kernel.

18. The electronic device of claim 17, wherein the kernel extract circuit is further configured to extract a block sparse mask that indicates one or more blocks of uncompressed kernel data to be filled with zero.

19. The electronic device of claim 18, wherein the block sparse mask includes a series of bits of a first value indicating a subset of kernel coefficients in the uncompressed kernel data that are zero and a second value indicating another subset of kernel coefficients in the uncompressed kernel data that are non-zero.

20. The electronic device of claim 17, wherein the kernel extract circuit comprises a kernel look-ahead buffer storing information on locations where kernel coefficients in the uncompressed kernel data are zero, the information on the locations sent to the MAD circuit to skip multiply-add operations associated with the kernel coefficients that are zero.
